(19) United States
(12) Patent Application Publication
(10) Pub. No.: US 2024/0302851 A1
(43) Pub. Date: Sep. 12, 2024

(54) PRESSURE LIMITER

(71) Applicant: NEOPERL GMBH, Müllheim (DE)

(72) Inventors: Martin FANGMEIER, Auggen (DE); Matthias HAUTH, Todtnau/Muggenbrunn (DE); Burkhard MEYER, Buggingen (DE)

(73) Assignee: Neoperl GmbH, Müllheim (DE)

(21) Appl. No.: 18/275,825

(22) PCT Filed: Mar. 14, 2022
(86) PCT No.: PCT/EP2022/056564

§ 371 Date: Aug. 4, 2023

(30) Foreign Application Priority Data
Mar. 17, 2021 (DE) 202021101347.8

(51) Int. Cl. G05D 16/10; E03B 7/07

(52) U.S. Cl. CPC G05D 16/106; E03B 7/075

(57) ABSTRACT

A pressure limiter (1) such as may be used, in particular, in sanitary water supply systems. So that the pressure limiter (1) may also be reliably used in water-carrying systems in which contamination of the water flow from particles, for example from sand grains, is likely, the pressure limiter (1) has guide faces (8), which have a cross-sectional taper (9) in at least one direction of a displacement movement of a sleeve (4) of the pressure limiter (1).

### CROSS-REFERENCE TO RELATED APPLICATIONS

The present application is a 371 National Phase of PCT/EP2022/056564, filed Mar. 14, 2022, which claims priority from German Patent Application No. 20 2021 101 347.8, filed Mar. 17, 2021.

### TECHNICAL FIELD

The invention relates to a pressure limiter having an internal space which is connected to the environment and is delimited by a sleeve which is displaceable along a guide.

### BACKGROUND

Such pressure limiters are used, for example, for sanitary water supplies and are already known in practice in various forms. The pressure limiters may also be referred to as pressure limiting valves and may be used to set the pressure in water-carrying systems to a certain limit value. The operating pressure inside the water-carrying system here is set in relation to an ambient pressure via a movable sleeve in opposition to a resetting force in order to thus achieve pressure limitation. The ambient pressure here serves as a reference pressure. Pressure limitation with reference to the ambient pressure represents a feature which distinguishes a pressure limiter from a flow regulator.

In practice, the problem arises that such water-carrying systems may occasionally be contaminated by particles, for example by sand. Such particles may impair the function of a pressure limiter of the type defined at the outset. The particles contained in the water flow may collect in the region of the guide and impair the movability of the sleeve. If this occurs, a necessary movement of the displaceable sleeve for pressure limitation is hindered or even prevented. This may lead to a failure of the pressure limiter.

### SUMMARY

The object of the invention is to provide a pressure limiter of the type mentioned at the outset, which may also be reliably used for pressure limitation in water-carrying systems in which contamination from particles, for example from sand grains, is a concern.

To achieve the object, a pressure limiter of the type mentioned at the outset is proposed, which includes one or more of the features disclosed herein. In particular, to achieve the object, it is proposed that the guide comprises guide projections, which are arranged on a base body of the pressure limiter, which base body is spaced from a sleeve inner wall of the sleeve, wherein the guide projections form guide faces facing the sleeve, in particular the sleeve inner wall, which have a cross-sectional taper in at least one direction or in both directions of the displacement movement of the sleeves. The cross-sectional tapers of the guide projections may be formed on the inflow side and/or on the outflow side here.

In this way, particles which may make their way into the internal space, delimited by the sleeve, of the pressure limiter may be prevented from depositing on the guide projections. The cross-sectional tapers may divert particles, for example sand grains, laterally so that they do not make their way into a clearance between the guide face and the sleeve inner wall.

In an embodiment of the pressure limiter which has proven particularly advantageous, the cross-sectional tapers are terminated by a radius. Each guide projection may have a cross-sectional taper with such a radius on the inflow side and/or on the outflow side. As a result of the radius at the end of the cross-sectional taper, it is possible to minimize or even completely avoid contact edges or contact faces which are aligned transversely to the movement direction of the sleeve relative to the guide projections and on which particles could accumulate.

In an embodiment of the pressure limiter, provision is made for the guide projections to be diamond-shaped in cross section and/or in plan view. Each of the guide projections of the guide therefore has two cross-sectional tapers, which may each be formed by half a diamond, in particular by a triangle, in cross section and/or in plan view.

It may be particularly advantageous if points of the diamond shape of the guide projections have an opening angle of less than 90° in the direction of the displacement movement, in particular on the inflow side and/or on the outflow side.

The cross-sectional tapers consequently have an acute angle, which promotes the above-described lateral deflection and/or displacement of particles which are possibly contained in the water flow.

To prevent particles from making their way between the sleeve inner wall and the guide faces formed at the guide projections, it may be advantageous if edges between the guide faces facing the sleeve and lateral delimiting walls of the guide projections are designed as sharp edges. As a result of a sharp edge at the transition between the respective guide face and lateral delimiting walls of the guide projections, it is possible to prevent particles which are deflected laterally due to the shape of the guide projections from still moving onto the guide face and thereby impairing the guidance of the sleeve.

The sleeve may be movable from an open position into an at least partially closed position in opposition to a resetting force of a resetting means, in particular a resetting spring. The resetting means here may be arranged between the base body and the sleeve of the pressure limiter.

The pressure limiter may be inserted or interconnected into a fluid line, in particular into a water line. The internal space of the pressure limiter may be delimited by the sleeve, which may also be referred to as a valve body.

The sleeve inner wall may be cylindrical. The guide faces may be coaxial to the sleeve inner wall and, in particular, have a convex curvature. This may promote good contact between the sleeve inner wall and the guide faces and therefore reliable guidance of the sleeve. As a result of the good contact between the sleeve and the guide faces, particles can moreover be prevented from making their way between the sleeve inner wall and the guide faces.

The pressure limiter may have a throughflow channel, in particular in its base body, which comprises at least one channel opening. The at least one channel opening may be at least partially closable by the sleeve for the purpose of pressure limitation. If the pressure in the line portion situated downstream of the pressure limiter increases, the sleeve, which is displaceable along the guide, may be moved under the pressure of the through-flowing medium from an open position into a closed position, in particular in opposition to the resetting force of the previously mentioned resetting element. In this closed position, the sleeve may at least partially close the channel opening of the at least one throughflow channel. If, with the increase in the pressure in the line portion situated downstream of the pressure limiter, the sleeve is pressed progressively in the direction of the base body and the pressure loss at the consequently decreasing channel opening therefore increases, the pressure in the line portion situated downstream of the pressure limiter may be limited to a certain maximum value.

To produce the pressure limiter, it may be advantageous if guide projections, which are arranged remotely from a mold-parting line, are positioned at an angle on a support, in particular on the base body, so that they are aligned in the demolding direction. This enables the guide projections, which are preferably arranged uniformly offset in the circumferential direction on the outer side of the base body, to be demolded together.

### BRIEF DESCRIPTION OF THE DRAWINGS

The invention is described in more detail below with the aid of an exemplary embodiment, but without being restricted to this exemplary embodiment. Further exemplary embodiments of the invention arise through combining the features of individual or multiple claims with one another and/or in combination with individual or multiple features of the exemplary embodiment.

In the drawings:

FIG. 1 shows an isometric representation of a pressure limiter, wherein the pressure limiter comprises a base body, in which a throughflow channel is formed, and a sleeve, which is displaceably guided along a guide on the base body, wherein the guide has a plurality of diamond-shaped guide projections arranged uniformly on the outer circumference of the base body,

FIG. 2 shows the detail denoted by the circle K in FIG. 1 in an enlarged representation,

FIGS. 3-5 show side views of the pressure limiter shown in the previous figures in an open position (FIG. 3), in an intermediate position (FIG. 4) and in a partially closed representation, in which the sleeve partially closes channel openings of the throughflow channel in the base body and thus halves a throughflow through the pressure limiter compared to the position of the sleeve which is shown in FIG. 3,

FIGS. 6-8 show sectional side views of the pressure limiter shown in FIGS. 3 to 5,

FIGS. 9-11 show isometric representations of the pressure limiters illustrated in FIGS. 3 to 8,

FIG. 12 shows a side view of the pressure limiter,

FIG. 13 shows a view of the pressure limiter cut along the line denoted by XIII-XIII in FIG. 12,

FIG. 14 shows a sectional view of the pressure limiter,

FIG. 15 shows an exploded illustration of the pressure limiter, and

FIG. 16 shows an isometric representation of the base body of the pressure limiter.

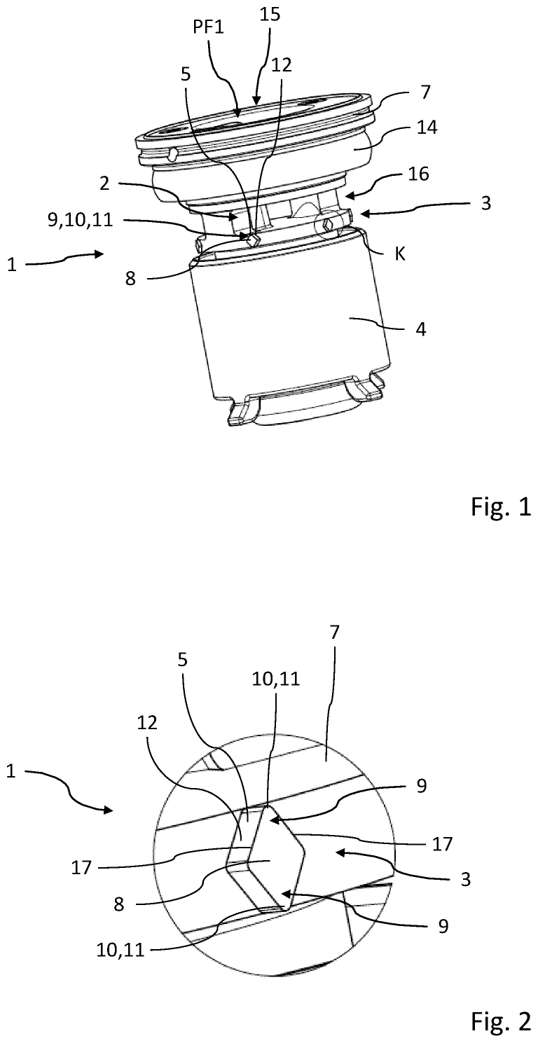

### DETAILED DESCRIPTION

All figures show at least parts of a pressure limiter which is denoted as a whole by 1. The pressure limiter 1 comprises an internal space 2, which, in the position of use of the pressure limiter 1, is connected to the environment via a connection, for example via an opening and/or a bore. A flow can pass through the pressure limiter 1 in the direction of the arrow Pf1 and the pressure limiter may be inserted or interconnected into a water line in order to limit the water pressure in a line portion situated downstream of the pressure limiter 1 to a specified maximum value. The pressure limiter 1 may also be referred to as a pressure reducing valve.

As a result of the connection between the internal space 2 and the environment, the ambient pressure may be taken into account as a reference during the pressure limitation by the pressure limiter 1. The internal space 2 is delimited by a sleeve 4, which is displaceable along a guide 3. The guide 3 comprises a plurality of guide projections 5, which are arranged on a base body 7 of the pressure limiter 1, which base body is arranged at a spacing from a sleeve inner wall 6 of the sleeve 4.

The figures illustrate that the guide projections 5 are arranged with a uniform distribution on an outer side of the base body 7 of the pressure limiter 1. The guide projections 5 form the guide faces 8 facing the sleeve 4, which are provided with cross-sectional tapers 9 in both directions of the displacement movement of the sleeve 4.

The cross-sectional tapers 9 each have a radius 10 at the end with which they are terminated. By way of example, FIGS. 2 and 16 show that the guide projections 5 are diamond-shaped in cross section or in plan view. Points 11 on the inflow side and on the outflow side of the diamond shape or points 11 in the direction of the displacement movement are provided with an opening angle of less than 90°. FIG. 2 furthermore shows that sharp edges 17 are formed between the guide faces 8 facing the sleeve 4 and lateral delimiting walls 12 of the guide projections 5. The sharp edges 17 prevent particles which are diverted laterally due to the shape of the guide projections 5 from making their way onto the guide faces 8, and therefore between the guide faces 8 and the sleeve inner wall 6 of the sleeve 4, and impairing the guidance 3 of the sleeve 4 there.

The sectional illustration according to FIGS. 6 to 8 and 15 illustrate that the sleeve 4 may be moved from an open position into an at least partially closed position in opposition to a resetting force of a resetting means 13, in this case a resetting spring. The resetting means 13 is arranged between the base body 7 and the sleeve 6 here.

Two seals 14 of the pressure limiter 1 are arranged on the base body 7. The pressure limiter 1 may be inserted into a housing (not shown in the figures). The housing may have at least one corresponding thread for inserting the housing with the pressure limiter 1 into a line and/or interconnecting it between two line portions. The housing may have a connection, in particular a line and/or a bore, via which the internal space 2 of the pressure limiter 1 arranged within the housing may be in communication with the ambient pressure.

The pressure limiter 1 has a throughflow channel 15 formed in its base body 7. The throughflow channel 15 has two channel openings 16, which can be at least partially closed by the sleeve 4 for the purpose of pressure limitation.

If the pressure increases in the line portion situated downstream of the pressure limiter 1, the sleeve 4, which is displaceably guided along the guide 3, is moved under the pressure of the through-flowing medium from an open position (shown by way of example in FIG. 4) into a partially closed position (shown by way of example in FIG. 5) in opposition to the resetting element 13. In this partially closed position, the sleeve 4 closes the two channel openings 16 of the throughflow channel 15, at least partially. Since, with the increase in the fluid pressure in the line portion situated downstream of the pressure limiter 1, the sleeve 4 is pressed progressively in the direction of the base body 7 in opposition to the resetting force of the at least one resetting element 13 and the pressure loss at the consequently decreasing channel opening 16 therefore increases, the pressure of the fluid in the line portion situated downstream of the pressure limiter 1 is limited to a specified maximum value.

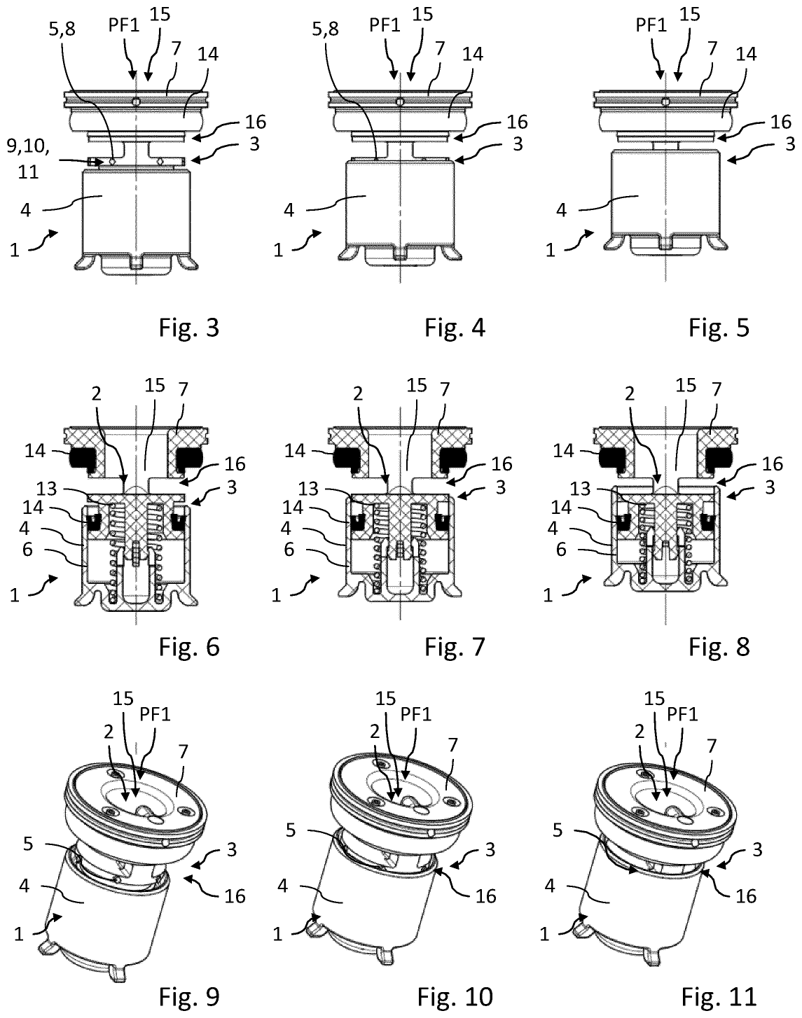

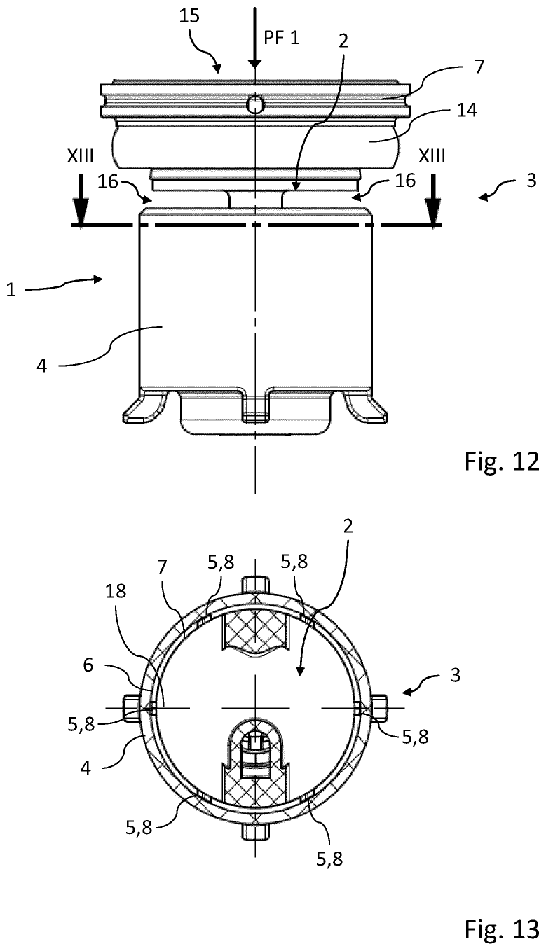

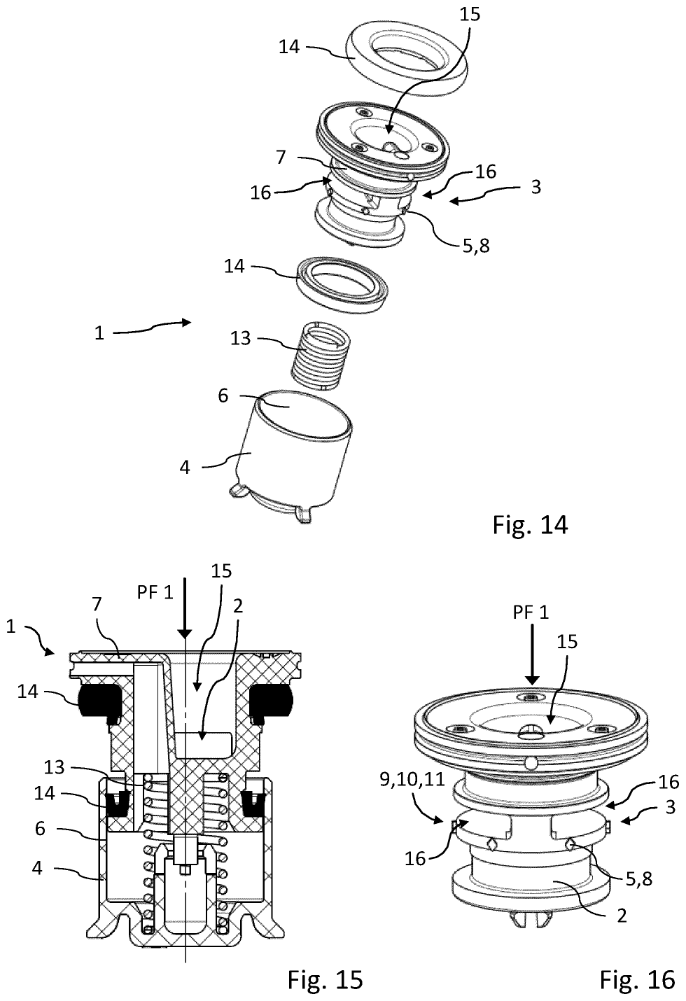

FIGS. 3, 6 and 9 show the sleeve 4 in its open position relative to the base body 7 of the pressure limiter 1. FIGS. 4, 7 and 10 show the sleeve 4 of the pressure limiter 1 in an intermediate position, in which the throughflow through the pressure limiter 1 is already somewhat limited. The sleeve 4 already lies on the guide faces 8 of the guide projections 5 in this intermediate position.

FIGS. 5, 8 and 11 show the pressure limiter 1 with the sleeve 4 positioned in the partially closed position. In this position, the sleeve 4 closes the channel openings 16 to the maximum extent. The throughflow through the pressure limiter 1 is thus restricted to half the throughflow permitted by the pressure limiter 1 when the sleeve 4 assumes the open position (shown in FIGS. 3, 6 and 9) relative to the base body 7.

The sleeve inner wall 6 is cylindrical and the guide faces 8 are curved and coaxial to the sleeve inner wall 6. The sleeve 4 therefore lies with good contact against the guide faces 8.

FIG. 13 shows that guide projections 5, which are arranged remotely from a mold-parting line 18, are positioned at an angle on a support, namely on the base body 7, so that they are aligned in the demolding direction. This enables the guide projections 5, which are arranged uniformly offset in the circumferential direction on the outer side of the base body 7, to be demolded together and may simplify the production of the pressure limiter 1.

The invention relates to improvements in the technical field of the pressure limiter 1 such as may be used, in particular, in sanitary water supply systems. So that the pressure limiter 1 may also be reliably used in water-carrying systems in which contamination of the water flow from particles, for example from sand grains, is likely, the pressure limiter 1 has guide faces 8, which have a cross-sectional taper 9 in at least one direction of a displacement movement of a sleeve 4 of the pressure limiter 1.

### LIST OF REFERENCE SIGNS

1 Pressure limiter
2 Internal space
3 Guide
4 Sleeve
5 Guide projection
6 Sleeve inner wall
7 Base body
8 Guide face
9 Cross-sectional taper
10 Radius
11 Points
12 Delimiting wall
13 Resetting means
14 Seal
15 Throughflow channel
16 Channel opening
17 Edge
18 Mold-parting line
PF 1 Throughflow direction

1. A pressure limiter (1), comprising:
an internal space (2), which is connected to environment and is delimited by a sleeve (4) which is displaceable along a guide (3);
the guide (3) comprises guide projections (5), which are arranged on a base body (7);
the base body is spaced from a sleeve inner wall (6); and
the guide projections (5) form guide faces (8) facing the sleeve (4) that have a cross-sectional taper in a least one direction of a displacement movement of the sleeve (4).

2. The pressure limiter (1) as claimed in claim 1, wherein the cross-sectional taper (9) terminates with a radius (10).

3. The pressure limiter (1) as claimed in claim 1, wherein the guide projections (5) are diamond-shaped in at least one of a cross section or plan view.

4. The pressure limiter (1) as claimed in claim 1, wherein edges (17) between the guide faces (8) facing the sleeve (4) and lateral delimiting walls (12) of the guide projections (5) are sharp edges.

5. The pressure limiter (1) as claimed in claim 1, wherein the sleeve (4) is movable from an open position into an at least partially closed position in opposition to a resetting force of a resilient resetting element (13).

6. The pressure limiter (1) as claimed claim 1, wherein the sleeve inner wall (6) is cylindrical.

7. The pressure limiter (1) as claimed in claim 1, further comprising a throughflow channel (15) which has at least one channel opening (16).

8. The pressure limiter (1) as claimed in claim 1, wherein the guide projections (5) are arranged offset from one another in a circumferential direction of the base body (7).

9. The pressure limiter (1) as claimed in claim 3, wherein points (11) of the diamond shape have an opening angle of less than 90° in a direction of the displacement movement on at least one of an inflow side or an outflow side.

10. The pressure limiter (1) as claimed in claim 5, wherein the resilient resetting element comprises a resetting spring arranged between the base body (7) and the sleeve (4).

11. The pressure limiter (1) as claimed in claim 1, wherein the guide faces (8) are coaxial to the sleeve inner wall (6).

12. The pressure limiter (1) as claimed in claim 7, wherein the at least one channel opening (16) is at least partially closable by the sleeve (4) for limiting pressure.

13. The pressure limiter (1) as claimed in claim 1, wherein the guide projections (5), which are arranged remotely from a mold-parting line, are positioned at an angle on the base body such that they are aligned in a demolding direction.
